(19) United States
(12) Patent Application Publication
(10) Pub. No.: US 2007/0192574 A1
(43) Pub. Date: Aug. 16, 2007

(54) Branch target buffer, a branch prediction circuit and method thereof

(75) Inventor: Gi-Ho Park, Seoul (KR)

Correspondence Address: HARNESS, DICKEY & PIERCE, P.L.C., P.O. BOX 8910, RESTON, VA, 20195, US

(73) Assignee: Samsung Electronics Co. Ltd.

(21) Appl. No.: 11/700,780

(22) Filed: Feb. 1, 2007

(30) Foreign Application Priority Data
Feb. 13, 2006 (KR) 10-2006-0013853

(51) Int. Cl. G06F 9/00

(52) U.S. Cl. 712/239

(57) ABSTRACT

A branch target buffer, a branch prediction circuit and a method thereof are provided. The example branch target buffer may include a memory cell array storing a branch address and a target address, a decoder connected to the memory cell array through a word line, and providing a word line voltage to a selected word line in response to a fetch address, a sense amp connected to the memory cell array through a bit line and sensing and amplifying data of a selected memory cell and sense amp enable circuitry connected to the word line, the sense amp enable circuitry storing branch prediction information and controlling an operation of the sense amp based on the branch prediction information. The example method may be directed to a method of operating a branch target buffer, including determining whether an instruction to be executed by a processor is a branch instruction, determining, if the instruction is determined to be a branch instruction, whether the branch instruction is predicted to be taken and selectively buffering instructions, from one or more memory cells, associated with the branch instruction based on whether the branch instruction is predicted to be taken.

### PRIORITY STATEMENT

This U.S. non-provisional patent application claims priority under 35 U.S.C. §119 of Korean Patent Application No. 2006-13853, filed on Feb. 13, 2006, the entire contents of which are hereby incorporated by reference.

### BACKGROUND OF THE INVENTION

1. Field of the Invention

Example embodiments of the present invention relate generally to a branch target buffer, a branch prediction circuit and method thereof, and more particularly to a branch target buffer, a branch prediction circuit and a method of operating a branch target buffer.

2. Description of the Related Art

Microprocessors may be called upon to handle increasingly burdensome processing loads. A pipelining process may allow a conventional microprocessor to process multiple instructions in parallel. A conventional pipelining process may include a number of operations, such as instruction fetching, instruction decoding and instruction executing. In a pipelined processor, instructions may be executed sequentially (e.g., first fetching, second decoding, third executing, etc.).

A performance of the pipelined processor may be based on a branch operation. Branch operations may refer to operations which may proceed in one of a number of alternative ways. In branch operations, if a given condition within the branch operation is determined to be satisfied during execution, the branch may be taken; otherwise, the branch is not taken. If the branch is taken, a different subsequent set of instructions may be fetched and executed. Because branch operations may potentially change the instruction flow of a program such that other pipelined instructions are no longer executed, the branch operation may lower the performance of the processor because, if a branch instruction is fetched, the pipelined processor may not immediately recognize an address of an instruction to be executed or fetched next (e.g., because the branch instruction may not be recognized, because of uncertainty as to whether the branch will be taken, etc.).

After it is determined whether or not the branch condition in a branch instruction or operation is satisfied, an address of a next instruction to be executed may be determined. Accordingly, as discussed above, if the condition of the branch instruction is satisfied, the branch instruction may be ‘taken’; if not, the branch instruction may be ‘not taken’.

Branch prediction may be used to predict a target address (e.g., for a next instruction) and may “randomly” execute an instruction corresponding to the predicted target address while the target address is computed by determining whether the condition of a branch instruction is true or false. If the branch prediction is correct, the random execution of the instruction may be appropriate, and a pipeline break (e.g., a condition where the “true” instructions were not being processed in the pipeline) may not occur. In contrast, if the branch prediction is wrong, recovery may be performed to obtain a correct program execution path. A recovery from erroneously executed instructions may include flushing the pipeline and then fetching, decoding and executing the proper instructions.

Conventional branch prediction methodologies may include static branch prediction and dynamic branch prediction. Static branch prediction may determine whether a branch instruction is taken or not taken before a given program execution. In contrast, dynamic branch prediction may determine whether a branch instruction is taken or not taken based on a history of program execution. Generally, dynamic branch prediction may have a higher prediction success rate or “hit ratio” as compared to that of static branch prediction.

In order to reduce a potential performance degradation caused by a missed branch instruction, a branch target buffer (BTB) may be used. The branch target buffer may store an address of a branch instruction (hereinafter, referred to as a “branch address”), and a target address to be branched. The branch target buffer may read a stored target address if a branch instruction is predicted as taken, and may fetch an instruction of the corresponding target address.

Because branch prediction may be made through the branch target buffer for each instruction in an embedded processor (e.g., an ARM processor), a significant amount of power may be allocated to the branch target buffer during an operation of the embedded processor. A pre-decoding operation (e.g., to earlier identify instructions as branch instructions or non-branch instructions) may be performed to mitigate the amount of allocated power such that branch prediction may only be performed for branch instructions. However, pre-decoding operations may increase the complexity of the pipeline process and/or increase a delay of an instruction fetch operation. Also, because access to the branch target buffer may be activated even if the branch instruction is predicted as not taken, power consumption may increase.

### SUMMARY OF THE INVENTION

An example embodiment of the present invention is directed to a branch target buffer, including a memory cell array storing a branch address and a target address, a decoder connected to the memory cell array through a word line, and providing a word line voltage to a selected word line in response to a fetch address, a sense amp connected to the memory cell array through a bit line and sensing and amplifying data of a selected memory cell and sense amp enable circuitry connected to the word line, the sense amp enable circuitry storing branch prediction information and controlling an operation of the sense amp based on the branch prediction information.

Another example embodiment of the present invention is directed to a method of operating a branch target buffer, including determining whether an instruction to be executed by a processor is a branch instruction, determining, if the instruction is determined to be a branch instruction, whether the branch instruction is predicted to be taken and selectively buffering instructions, from one or more memory cells, associated with the branch instruction based on whether the branch instruction is predicted to be taken.

Another example embodiment of the present invention is directed to a branch target buffer controlling an operation of a sense amp in response to branch prediction information so as to reduce power consumption.

### BRIEF DESCRIPTION OF THE FIGURES

The accompanying drawings are included to provide a further understanding of the invention, and are incorporated in and constitute a part of this specification. The drawings illustrate example embodiments of the present invention and, together with the description, serve to explain principles of the present invention.

FIG. 1 is a block diagram of a microprocessor including a branch prediction circuit according to an example embodiment of the present invention.

FIG. 2 is a block diagram of the branch prediction circuit of FIG. 1 according to another example embodiment of the present invention.

FIG. 3 is a state diagram illustrating a branch prediction process of branch prediction control logic of the branch prediction circuit of FIG. 2 according to another example embodiment of the present invention.

FIG. 4 is a block diagram of a branch target buffer of the branch prediction circuit of FIG. 2 according to another example embodiment of the present invention.

FIG. 5 is a circuit diagram of sense amp enable circuitry of the branch target buffer of FIG. 4 according to another example embodiment of the present invention.

### DETAILED DESCRIPTION OF EXAMPLE EMBODIMENTS

Detailed illustrative example embodiments of the present invention are disclosed herein. However, specific structural and functional details disclosed herein are merely representative for purposes of describing example embodiments of the present invention. Example embodiments of the present invention may, however, be embodied in many alternate forms and should not be construed as limited to the embodiments set forth herein.

Accordingly, while example embodiments of the invention are susceptible to various modifications and alternative forms, specific embodiments thereof are shown by way of example in the drawings and will herein be described in detail. It should be understood, however, that there is no intent to limit example embodiments of the invention to the particular forms disclosed, but conversely, example embodiments of the invention are to cover all modifications, equivalents, and alternatives falling within the spirit and scope of the invention. Like numbers may refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. Conversely, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, “on” versus “directly on”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

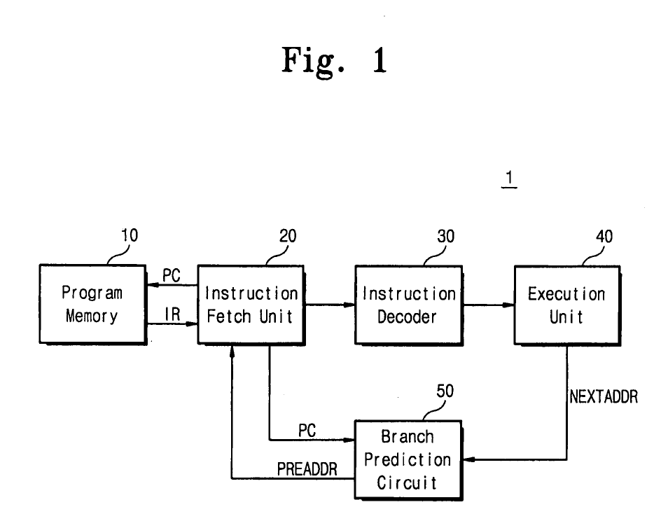

FIG. 1 is a block diagram of a microprocessor 1 including a branch prediction circuit 50 according to an example embodiment of the present invention. In the example embodiment of FIG. 1, the microprocessor 1 may include a program memory 10, an instruction fetch unit 20, an instruction decoder 30, an execution unit 40 and the branch prediction circuit 50.

In the example embodiment of FIG. 1, the program memory 10 may receive a fetch address from the instruction fetch unit 20. The fetch address may correspond to a value of a program counter PC (not shown) of the instruction fetch unit 20. In the example embodiment of FIG. 1, the fetch address may be indicated as ‘PC’. The program memory 10 may provide an instruction IR to the instruction fetch unit 20 at each cycle (e.g., clock cycle) in response to the fetch address PC. The instruction decoder 30 may receive an instruction fetched from the instruction fetch unit 20, decode the received instruction and provide a decoded code to the execution unit 40. The execution unit 40 may determine whether the condition of a conditional instruction (e.g., a branch instruction) decoded by the instruction decoder 30 is true or false (e.g., satisfied or unsatisfied), and may generate an actual branch address NEXTADDR based on the determination result. The actual branch address NEXTADDOR may be provided to the branch prediction circuit 50.

In the example embodiment of FIG. 1, the branch prediction circuit 50 may receive an address, namely, a fetch address PC, of a branch instruction from the instruction fetch unit 20. The branch prediction circuit 50 may generate a branch prediction address PREADDR in response to the fetch address PC. The branch prediction circuit 50 may determine whether the branch prediction address PREADDDR is the same as the actual branch address NEXTADDR provided from the execution unit 40.

In the example embodiment of FIG. 1, if the branch prediction address PREADDR and the actual branch address NEXTADDR are determined to be the same, the branch prediction is a “hit” (e.g., correctly predicted). Thus, no pipeline errors may be determined to have occurred. Alternatively, if the branch prediction address PREADDR and the actual branch address NEXTADDR are determined not to be the same, the branch prediction is a “miss” (e.g., incorrectly predicted). In order to re-branch to the actual branch address NEXTADDR, the branch prediction address may be changed to the actual branch address NEXT ADDR, and the changed address may be output.

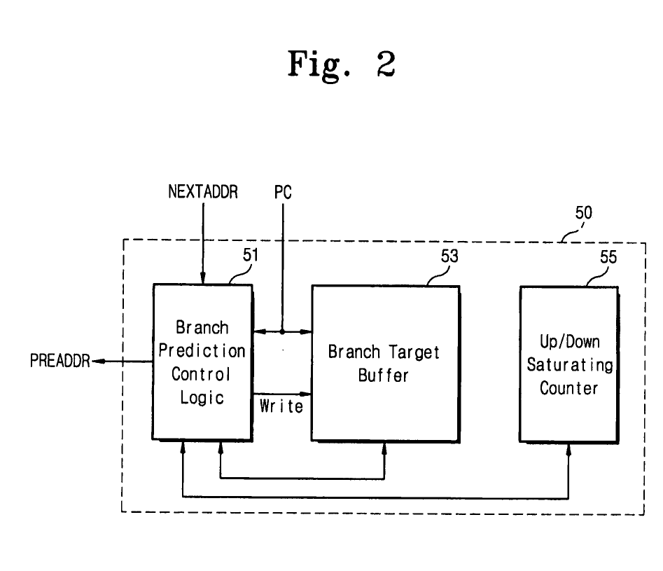

FIG. 2 is a block diagram of the branch prediction circuit 50 of FIG. 1 according to another example embodiment of the present invention. In the example embodiment of FIG. 2, the branch prediction circuit 50 may include a branch prediction control logic 51, a branch target buffer (BTB) 53 and an up/down saturating counter 55.

In the example embodiment of FIG. 2, the branch prediction control logic 51 may receive a fetch address PC from the branch fetch unit 20 (illustrated in FIG. 1). The branch prediction control logic 51 may predict whether to branch to a target address of a branch instruction (“taken”) or to perform a next sequential instruction (“not taken”). The branch prediction control logic 51 generates a branch prediction address PREADDR based on the prediction result.

In the example embodiment of FIG. 2, the branch prediction control logic 51 may receive an actual branch address NEXTADDOR from the execution unit 40 (illustrated in FIG. 1). The branch prediction control logic 51 may determine whether or not the branch prediction address PREADDR and the actual branch address NEXTADDOR are the same. The branch prediction control logic 51 may control the branch target buffer 53 and the up/down saturating counter 55 based on the determination result.

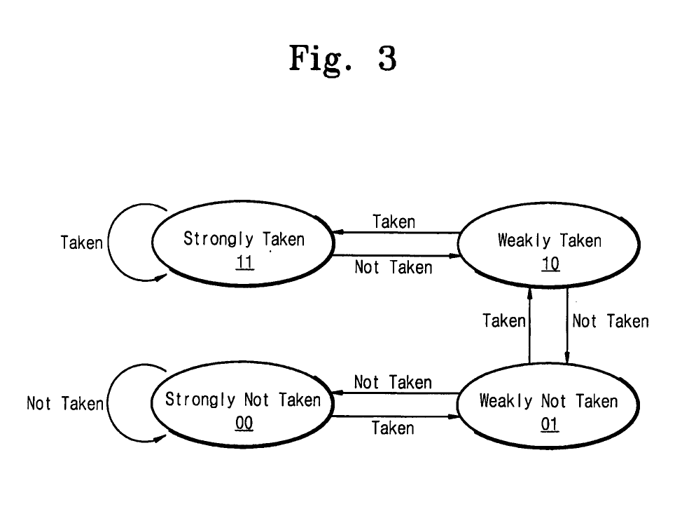

In the example embodiment of FIG. 2, the branch prediction control logic 51 may predict a next branch direction based on the previous branch prediction result, for example, based on whether a branch instruction is taken or not taken with a given history or tendency. The branch prediction control logic 51 may obtain branch prediction information using the up/down saturating counter 55. A branch prediction process of the branch prediction control logic 51 and an operation of the up/down saturating counter 55 will now be described with reference to the example embodiment of FIG. 3.

FIG. 3 is a state diagram illustrating a branch prediction process of the branch prediction control logic 51 of FIG. 2 according to another example embodiment of the present invention. In the example embodiment of FIG. 3, the branch prediction control logic 51 may obtain branch prediction information using the up/down saturating counter 55 (illustrated in FIG. 2). With respect to the example embodiment of FIG. 3, the up/down saturating counter 55 is hereinafter described as a 2_bit counter. However, it is understood that other example embodiments of the present invention may embody the up/down saturating counter 55 as any well-known type of counter (e.g., a decimal counter, a 3 bit binary counter, etc.).

In the example embodiment of FIG. 3, the up/down saturating counter 55 may include four states of ‘00’, ‘01’, ‘10’, and ‘11’. The states ‘00’ and ‘01’ may correspond to Not-Taken states. In particular, the state ‘00’ may correspond to a Strongly Not-Taken state, and the state ‘01’ may correspond to a Weakly Not-Taken state. The states ‘11’ and ‘10’ may correspond to Taken states. In particular, the state ‘11’ may correspond to a Strongly Taken state, and the state ‘10’ may correspond to a Weakly Taken state.

In the example embodiment of FIG. 3, the up/down saturating counter 55 may receive an up control signal (UP) and a down control signal (DOWN) from the branch prediction control logic 51. The up/down saturating counter 55 may adjust a current state in response to the up control signal (UP) or the down control signal (DOWN). For example, the up/down saturating counter 55 may transition a current state to a “more” Taken state in response to the up control signal (UP), and may transition the current state to a “more” Not-Taken state in response to the down control signal (DOWN). Alternatively, if the down control signal DOWN is received at the state ‘00’, the up/down saturating counter 55 may maintain the state ‘00’. Likewise, if the up control signal (UP) is received at the state ‘11’, the up/down saturating counter 55 may maintain the state ‘11’.

Returning to the example embodiment of FIG. 2, the branch prediction control logic 51 may obtain branch prediction information using the up/down saturating counter 55. Thus, the branch prediction control logic 51 may provide an up control signal (UP) or a down control signal (DOWN) to the up/down saturating counter 55 based on a branch result. For example, if the branch result is ‘Taken’, the branch prediction control logic 51 may generate (e.g., activate) the up control signal UP, and the up/down saturating counter 55 may increase a count value (e.g., or “state value” as shown in FIG. 3). In contrast, if the branch result is ‘Not-Taken’, the branch prediction control logic 51 may generate (e.g., activate) a down control signal DOWN, and the up/down saturating counter 55 may decrease a count value (e.g., or “state value” as shown in FIG. 3).

In the example embodiment of FIGS. 2 and 3, the branch target buffer 53 may perform branch prediction based on the count value of the up/down saturating counter 55. Thus, if the count value (e.g., or state value as shown in FIG. 3) of the up/down saturating counter 55 is ‘00’ or ‘01’, the branch target buffer 53 may predict a branch instruction as not taken, and if the count value of the up/down saturating counter 55 is ‘11’ or ‘10’, the branch target buffer 53 may predict the branch instruction as taken.

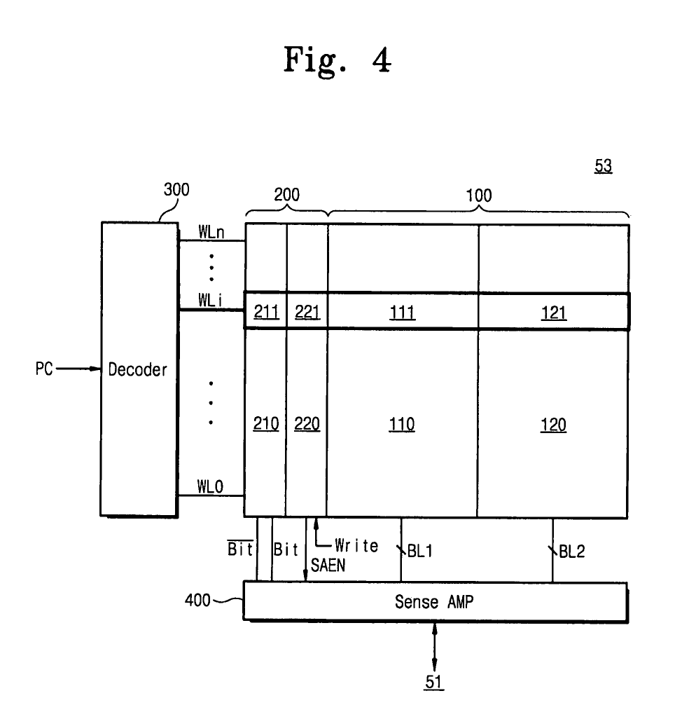

FIG. 4 is a block diagram of the branch target buffer 53 of FIG. 2 according to another example embodiment of the present invention. In the example embodiment of FIG. 4, the branch target buffer 53 may include a memory cell array 100, a sense amp enable circuitry 200, a decoder 300 and a sense amp 400. In an example, the branch target buffer 53 may be implemented as a random access memory (RAM), such as a static RAM (SRAM), a dynamic RAM (DRAM), etc. Hereinafter, for convenience of description, the branch target buffer 53 will be described as being implemented as an SRAM.

In the example embodiment of FIG. 4, the memory cell array 100 may include a plurality of memory cells (not shown). In an example, each memory cell may be embodied as a well-known SRAM cell. The memory cell array 100 may include first and second storage regions 110 and 120. The first storage region 110 may store a branch address. The second storage region 120 may store a target address. In an example, the target address may correspond to an address to be actually branched. The memory cell array 100 may be connected to a decoder 300 through a word line WL, and may further be connected to a sense amp 400 through a bit line BL.

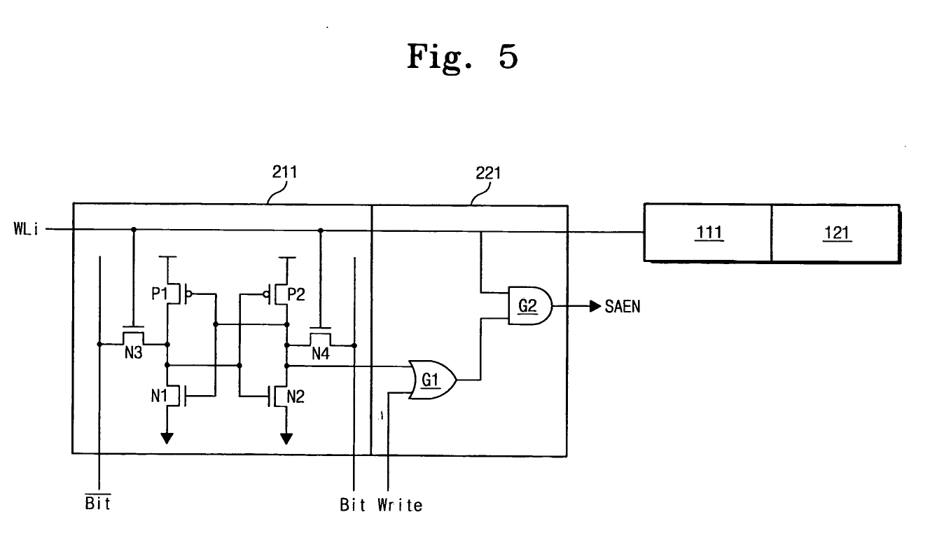

In the example embodiment of FIG. 4, a sense amp enable circuitry 200 may be positioned between the memory cell array 100 and the decoder 300. The sense amp enable circuitry 200 may include branch prediction information storage circuits 210 and enable signal generating circuits 220. The branch prediction information storage circuits 210 may be connected to word lines WL0˜WLn, and may store branch prediction information. In an example, the branch prediction information may correspond to either Taken information (e.g., to indicate a “taken” branch instruction) or Not-Taken information (e.g., to indicate a “not taken” branch instruction). In an example, each of the branch prediction information storage circuits 210 may be implemented as a 1_bit SRAM cell. The enable signal generating circuit 220 may generate a sense amp enable signal (SAEN) based on the branch prediction information stored in the branch prediction information storage circuit 210. The enable signal generating circuit 210 may provide a sense amp enable signal (SAEN) to the sense amp 400. An example configuration and operation of the sense amp enable circuitry 200 will be described in greater detail later with reference to the example embodiment of FIG. 5.

In the example embodiment of FIG. 4, the decoder 300 may be connected to the memory cell array 100 through the word lines WL0˜WLn. The decoder 300 may receive a fetch address PC, and may provide a word line voltage to a selected word line WLi.

In the example embodiment of FIG. 4, the sense amp 400 may be connected to the memory cell array 100 through bit lines BL1 and BL2. The sense amp 400 may be further connected to the branch prediction information circuits 210 through bit lines Bit and /Bit. The sense amp 400 may read a target address from the memory cell array 100 by control of the branch prediction control logic 51 (illustrated in FIG. 2). The sense amp 400 may update data stored in the memory cell array 100 and the branch prediction information storage circuits 210. The sense amp 400 may block or prevent access to a selected memory cell in response to a sense amp enable signal SAEN provided from the enable signal generating circuitry 200. Accordingly, if the branch prediction information is ‘Not-Taken’, access to the selected memory cell may be blocked or prevented, thereby reducing a power consumption of the branch target buffer 53.

FIG. 5 is a circuit diagram of the sense amp enable circuitry 211 and 221 of FIG. 4 according to another example embodiment of the present invention. In the example embodiment of FIG. 5, the sense amp enable circuitry 211 and 221 may be connected to a selected word line WLi, and may include a 1_bit SRAM cell 211 and an enable signal generating circuit 221.

In the example embodiment of FIG. 5, the 1_bit SRAM cell 211 may store branch prediction information. The branch prediction information may correspond to either ‘Taken’ or ‘Not-Taken’ information. In an example, the Taken or Not-Taken information may be the same as data stored in an upper bit of the up/down saturating counter 55 (illustrated in FIG. 2). Referring to the example embodiment of FIG. 3, if a count value (e.g., or “state value) of the up/down saturating counter 55 is ‘00’ or ‘01’, the 1_bit SRAM cell 211 may store the Not-Taken information (e.g., indicating a ‘not taken’ prediction for a next branch instruction). In contrast, if the count value (e.g., or “state value”) of the up/down saturating counter 55 is ‘11’ or ‘10’, the 1_bit SRAM cell 211 may store the Taken information (e.g., indicating a ‘taken’ prediction for a next branch instruction).

In the example embodiment of FIG. 5, the 1_bit SRAM cell 211 may include first and second PMOS transistors P1 and P2, and first to fourth NMOS transistors N1˜N4. The selected word line WLi may be connected to gates of the third and fourth NMOS transistors N3 and N4, and the bit lines Bit and /Bit may be connected to drains thereof. 1_bit branch prediction information may be stored in drains of the second PMOS transistor P2 and the second NMOS transistor N2. Thus, if the branch prediction information corresponds to the Taken information, data at a first logic level (e.g., a higher logic level or logic “1”) may be stored, and in the case of the Not-Taken information, data at a second logic level (e.g., a lower logic level or logic “0”) may be stored.

In the example embodiment of FIG. 5, the enable signal generating circuit 221 may generate a sense amp enable signal SAEN based on the branch prediction information stored in the 1_bit SRAM cell 211. In an example, the enable signal generating circuit 221 may generate the sense amp enable signal SEAN if the branch prediction information corresponds to the Taken information. Alternatively, if the branch prediction information corresponds to the Not-Taken information, the enable signal generating circuit 221 may not generate the sense amp enable signal SAEN.

In the example embodiment of FIG. 5, the enable signal generating circuit 221 may include first and second gates G1 and G2. The first gate G1 may receive branch prediction information and a write signal (write), and may perform an OR operation. In an example, the write signal (write) may be provided from the branch prediction control logic 51 (illustrated in FIG. 2). If the write signal (write) is set to the first logic level (e.g., a higher logic level or logic “1”), the first gate G1 may generate a signal set to the first logic level irrespective of a logic level of the branch prediction information. The second gate G2 may receive an output signal of the first gate G1 and a word line voltage of the selected word line WLi, and may perform an AND operation.

In the example embodiment of FIG. 5, the enable signal generating circuit 221 may generate a sense amp enable signal SAEN if the branch prediction information corresponds to the Taken information or, alternatively, the write signal (write) is input (e.g., at the first logic level). However, if the Not-Taken information is input to the 1_bit SRAM cell 211 during a read operation, the enable signal generating circuit 221 may not generate the sense amp enable signal SAEN. Accordingly, a selected memory cell may not be accessed if a branch prediction result is ‘Not-Taken’, thereby reducing power consumption. If the write signal (write) is activated (e.g., transitioned to the first logic level, such as a higher logic level or logic “1”), the enable signal generating circuit 221 may generate the sense amp enable signal SAEN irrespective of a logic level of the branch prediction information, thereby allowing a write operation to be performed normally (e.g., without blocking access to the memory cell indicated by the write operation).

In another example embodiment of the present invention, a branch target buffer may store branch prediction information, and may enable a sense amp based on the branch prediction information. The branch target buffer may include, for example, 1_bit SRAM cells to store the branch prediction information. Each of the 1_bit SRAM cells may be connected to a word line between a memory cell array and a decoder. If the branch prediction information corresponds to Taken information (e.g., indicating a branch instruction is predicted to be taken), the branch target buffer may enable the sense amp. Alternatively, if the branch prediction information corresponds to Not-Taken information (e.g., indicating a branch instruction is predicted not to be taken), the branch target buffer may disable the sense amp. Access to a selected memory cell may be allowed during a write operation because the write operation may be required to be performed irrespective of whether the branch prediction information corresponds to Taken or Not Taken information.

In another example embodiment of the present invention, access to a memory cell array may be blocked or prevented if the branch prediction information stored in the 1_bit SRAM cell corresponds to Not-Taken information, such that power consumption may be reduced. Also, because the branch prediction information may be stored in, for example, a 1_bit SRAM cell, power consumption in the branch target buffer may be reduced only by control of the word line without requiring a more complicated control circuit or longer time delay.

In another example embodiment of the present invention, a power consumption allocated to access of a branch target buffer may be reduced by approximately 40%.

In another example embodiment of the present invention, a branch target buffer may include a unit for storing branch prediction information. Thus, if a branch instruction is predicted as not taken, no access to the branch target buffer may be allowed, such that that power consumption in the branch target buffer may be reduced as compared to the conventional art.

Example embodiments of the present invention being thus described, it will be obvious that the same may be varied in many ways. For example, while the example embodiments are above described as directed to memory cells, state diagrams, counters, etc. of particular sizes (e.g., 2 bit counters, 1 bit memory cells, etc.), it is understood that other example embodiments need not be limited to such configurations and rather may scale to any sized counter, memory cell, state diagram, etc. Further, it is understood that the above-described first and second logic levels may correspond to a higher level and a lower logic level, respectively, in an example embodiment of the present invention. Alternatively, the first and second logic levels/states may correspond to the lower logic level and the higher logic level, respectively, in other example embodiments of the present invention.

Such variations are not to be regarded as a departure from the spirit and scope of example embodiments of the present invention, and all such modifications as would be obvious to one skilled in the art are intended to be included within the scope of the following claims.

What is claimed is:

1. A branch target buffer, comprising:
a memory cell array storing a branch address and a target address;
a decoder connected to the memory cell array through a word line, and providing a word line voltage to a selected word line in response to a fetch address;
a sense amp connected to the memory cell array through a bit line and sensing and amplifying data of a selected memory cell; and
sense amp enable circuitry connected to the word line, the sense amp enable circuitry storing branch prediction information and controlling an operation of the sense amp based on the branch prediction information.

2. The branch target buffer of claim 1, wherein the branch prediction information indicates whether a future branch instruction is taken or not taken.

3. The branch target buffer of claim 2, wherein the sense amp enable circuitry prevents access to the selected memory cell if the branch prediction information indicates that the future branch instruction is not taken.

4. The branch target buffer of claim 1, wherein the memory cell array is a Static Random Access Memory (SRAM) cell array.

5. The branch target buffer of claim 1, wherein the sense amp enable circuitry includes:
a branch prediction information storage circuit connected to the word line, the branch prediction information storage circuit storing the branch prediction information; and
an enable signal generating circuit generating a sense amp enable signal in response to the branch prediction information stored in the branch prediction information storage circuit, the enable signal generating circuit providing the sense amp enable signal to the sense amp.

6. The branch target buffer of claim 5, wherein the branch prediction information storage circuit is a single bit SRAM cell.

7. The branch target buffer of claim 5, wherein the enable signal generating circuit is an AND gate receiving the word line voltage and the branch prediction information, and performing an AND operation on the received word line voltage and the received branch prediction information.

8. The branch target buffer of claim 1, wherein the enable signal generating circuit is a logic gate providing the sense amp enable signal to the sense amp in response to the branch prediction information and an operation mode.

9. The branch target buffer of claim 8, wherein the logic gate includes:
a first gate receiving the branch prediction information and the operation mode, and performing an OR operation on the received branch prediction information and the operation mode; and
a second gate receiving the word line voltage and an OR operation result output from the first gate, and performing an AND operation on the received word line voltage and OR operation result.

10. The branch target buffer of claim 8, wherein, if the operation mode indicates a write mode, the logic gate provides the sense amp enable signal to the sense amp irrespective of a logic level of the branch prediction information.

11. A branch prediction circuit, comprising:
the branch target buffer of claim 1;
an up/down saturating counter increasing a count value if a given branch instruction is taken and decreasing the count value if the given branch instruction is not taken,
wherein the branch target buffer receives the count value from the up/down saturating counter, and performs branch prediction based on the received count value.

12. The branch prediction circuit of claim 11, wherein the branch prediction information equals an upper bit of the up/down saturating counter.

13. The branch prediction circuit of claim 11, wherein the branch prediction information indicates whether a future branch instruction is taken or not taken.

14. The branch prediction circuit of claim 13, wherein the sense amp enable circuitry prevents access to the selected memory cell if the branch prediction information indicates that the future branch instruction is not taken.

15. The branch prediction circuit of claim 11, wherein the memory cell array is a Static Random Access Memory (SRAM) cell array.

16. The branch prediction circuit of claim 15, wherein the sense amp enable circuitry comprises:
a branch prediction information storage circuit connected to the word line, the branch prediction information storage circuit storing the branch prediction information; and
an enable signal generating circuit generating a sense amp enable signal in response to the branch prediction information stored in the branch prediction information storage circuit, the enable signal generating circuit providing the sense amp enable signal to the sense amp.

17. The branch prediction circuit of claim 16, wherein the branch prediction information storage circuit is a single bit SRAM cell.

18. The branch prediction circuit of claim 16, wherein the enable signal generating circuit is an AND gate receiving the word line voltage and the branch prediction information, and performing an AND operation on the received word line voltage and the received branch prediction information.

19. The branch prediction circuit of claim 16, wherein the enable signal generating circuit is a logic gate providing the sense amp enable signal to the sense amp in response to the branch prediction information and an operation mode.

20. The branch prediction circuit of claim 19, wherein the logic gate includes:
a first gate receiving the branch prediction information and the operation mode, and performing an OR operation on the received branch prediction information and the operation mode; and
a second gate receiving the word line voltage and an OR operation result output from the first gate, and performing an AND operation on the received word line voltage and OR operation result.

21. The branch prediction circuit of claim 19, wherein, if the operation mode indicates a write mode, the logic gate provides the sense amp enable signal to the sense amp irrespective of a logic level of the branch prediction information.

22. A method of operating a branch target buffer, comprising:
determining whether an instruction to be executed by a processor is a branch instruction;
determining, if the instruction is determined to be a branch instruction, whether the branch instruction is predicted to be taken; and
selectively buffering instructions, from one or more memory cells, associated with the branch instruction based on whether the branch instruction is predicted to be taken.

23. The method of claim 22, wherein the selective buffering includes:
buffering the instructions, from the one or more memory cells, associated with the branch instruction if the branch instruction is predicted to be taken; and
blocking access to the one or more memory cells if the branch instruction is not predicted to be taken so as to reduce a power consumption of the branch target buffer.

24. The method of claim 22, wherein the instructions associated with the branch instructions are instructions which are only executed if the branch instruction is actually taken.
